(19) United States
(12) Patent Application Publication
(10) Pub. No.: US 2026/0178217 A1
(43) Pub. Date: Jun. 25, 2026

(54) STORAGE DEVICE

(71) Applicant: Hitachi Vantara, Ltd., Kanagawa-ken (JP)

(72) Inventors: Kenichi BETSUNO, Tokyo (JP); Yoshihiro YOSHII, Tokyo (JP); Takashi NAGAO, Tokyo (JP)

(73) Assignee: Hitachi Vantara, Ltd., Kanagawa-ken (JP)

(21) Appl. No.: 19/304,692

(22) Filed: Aug. 20, 2025

(30) Foreign Application Priority Data
Dec. 20, 2024 (JP) 2024-225060

(51) Int. Cl. G06F 3/06

(52) U.S. Cl. CPC G06F 3/0655; G06F 3/0625; G06F 3/0676; G06F 3/0679

(57) ABSTRACT

A storage device includes a host interface that communicates with a host and a processor. The processor executes an asynchronous process that is a process executed asynchronously with an access process that is a process related to reading and writing of data via the host interface and is a process on data derived from data received via the host interface, selects an operation mode of one or more hardware devices of the storage device from modes including a normal mode and a power saving mode in which a power consumption amount is less than a power consumption amount of the normal mode. The processor restricts the asynchronous process and maintains the power saving mode when the operation mode is the power saving mode.

### CLAIM OF PRIORITY

The present application claims priority from Japanese patent application JP 2024-225060 filed on Dec. 20, 2024, the content of which is hereby incorporated by reference into this application.

### BACKGROUND OF THE INVENTION

### 1. Field of the Invention

The present invention relates to control of an asynchronous process in a storage device.

### 2. Description of the Related Art

As methods of reducing cost involved with storage media of storage systems, technologies for reducing the amount of data, such as compression technologies and deduplication technologies, have become widespread. When these technologies for reducing amounts of data are applied, there are differences between data sizes written from hosts to storage systems and data sizes actually written to storage media. Therefore, in order to effectively use storage areas of storage media, a write-once data storage scheme (for example, log-structured storage) in which data after application of a reduction in an amount of data is written in a front-packed manner in an available area has been used.

In the write-once data storage scheme, when data is updated, access to data before update (valid data) is not made. Data in the state is referred to as garbage (invalid data). As a host repeatedly updates data and a storage system continues writing of update data, that is, writing of update data in an available area, a garbage amount increases and an available area decreases. The available area is an area where both valid data before update and garbage that is invalid data after update are not stored.

Therefore, when a write-once data storage scheme is used, a scheme is employed in which, in order to delete generated garbage, a proportion of garbage included in a predetermined storage area is calculated as an invalid rate and garbage collection is executed when the inefficient rate exceeds a predetermined threshold. Here, the garbage collection is a process of copying valid data to another available area and then releasing the predetermined storage area so that the predetermined storage area is reusable. For example, there is JP 2024-60809 A.

In recent years, from the viewpoint of an influence on an environment and operational cost, a reduction in power consumption in an information processing apparatus including a storage system has been required. As a technology for reducing power of an information processing apparatus, there is a technology for curbing power consumption of the entire apparatus by causing a hardware device (hereinafter referred to as a device) included in the apparatus to transition to a low power state (hereinafter referred to as a power saving mode). For example, JP 2010-244342 A discloses a technology in which, in an image forming apparatus to which a memory management control device is applied, a user detects that the apparatus has not been used for at least a predetermined time, and a device included in the apparatus transitions to a power saving mode according to a detection result. In the technology, garbage collection (referred to as garbage collection on a memory in order to distinguish from the garbage collection in the above-described data storage scheme) that is a memory management function of an operating system is executed when the device has not been used for a predetermined time, which curbs an influence on device performance in execution of garbage collection on a memory.

### SUMMARY OF THE INVENTION

For example, a storage system to which a function of reducing a data amount is applied is required to make an available capacity reusable by periodically executing the above-described garbage collection asynchronously with the access process in addition to a process of making an access request from a host computer (hereinafter referred to as a host) (hereinafter, referred to as an access process). In order to maintain access performance, it may be required not to execute a data amount reducing process in access synchronization but to execute a data amount reducing process executed asynchronously with an access process. However, with the execution of the asynchronous process, a load applied to a device such as a CPU and a drive increases, which leads to non-transition of a device to the power saving mode and non-execution of an asynchronous process in consideration of a power consumption amount.

When the technology of JP 2010-244342 A is applied to a storage system, there is a certain period of time in which the storage system is not used (an access request does not occur), and it is assumed that an available capacity can be collected in time. However, in a storage system in which high availability is required, the assumption that a sufficient period of time in which there is no access request will be secured does not hold.

As described above, there is a problem in execution of the asynchronous process in consideration of a power consumption amount in a storage system requiring high availability.

An aspect of the present invention is a storage device including: a host interface configured to communicate with a host; and a processor. The processor executes an asynchronous process that is a process executed asynchronously with an access process that is a process related to reading and writing of data via the host interface and is a process on data derived from data received via the host interface, selects an operation mode of one or more hardware devices of the storage device from modes including a normal mode and a power saving mode in which a power consumption amount is less than a power consumption amount of the normal mode, and restricts the asynchronous process and maintains the power saving mode when the operation mode is the power saving mode.

According to an aspect of the present invention, in the storage system, an asynchronous process can be executed in consideration of a power consumption amount.

### BRIEF DESCRIPTION OF THE DRAWINGS

FIG. 1 is a diagram illustrating a hardware configuration of a storage system according to an embodiment;

FIG. 2 is a diagram illustrating an overview of a method of controlling an asynchronous process according to an embodiment;

FIG. 3 is a diagram illustrating a logical configuration according to an embodiment;

FIG. 4 is a diagram illustrating a metadata management table according to an embodiment;

FIG. 5 is a diagram illustrating a page management table according to an embodiment;

FIG. 6 is a diagram illustrating a RAID configuration management table according to an embodiment;

FIG. 7 is a diagram illustrating a pool management table according to an embodiment;

FIG. 8 is a diagram illustrating a device management table according to an embodiment;

FIG. 9 is a diagram illustrating a write process according to an embodiment;

FIG. 10 is a diagram illustrating a garbage collection process according to an embodiment;

FIG. 11 is a diagram illustrating an asynchronous process execution determining process according to an embodiment; and

FIG. 12 is a diagram illustrating an asynchronous data amount reducing process according to an embodiment.

### DESCRIPTION OF THE PREFERRED EMBODIMENTS

Hereinafter, embodiments of the present invention will be described with reference to the drawings. In the accompanying drawings, functionally same elements may be denoted by the same numbers. The accompanying drawings illustrate specific embodiments and examples according to the principles of the present invention. The embodiments and examples are for the understanding of the present invention and should not be used for the restrictive interpretation of the present invention.

In the following description, when the same types of elements are described without being distinguished, a common code among the reference codes may be used. When the same types of elements are distinguished, a reference code (or an ID (for example, an identification number) of the element) may be used. For example, when a plurality of pages is not distinguished, the pages are described as “pages 70”. When the pages are distinguished, the pages are described as “page 70A” or “page 70B”. The same applies to other elements.

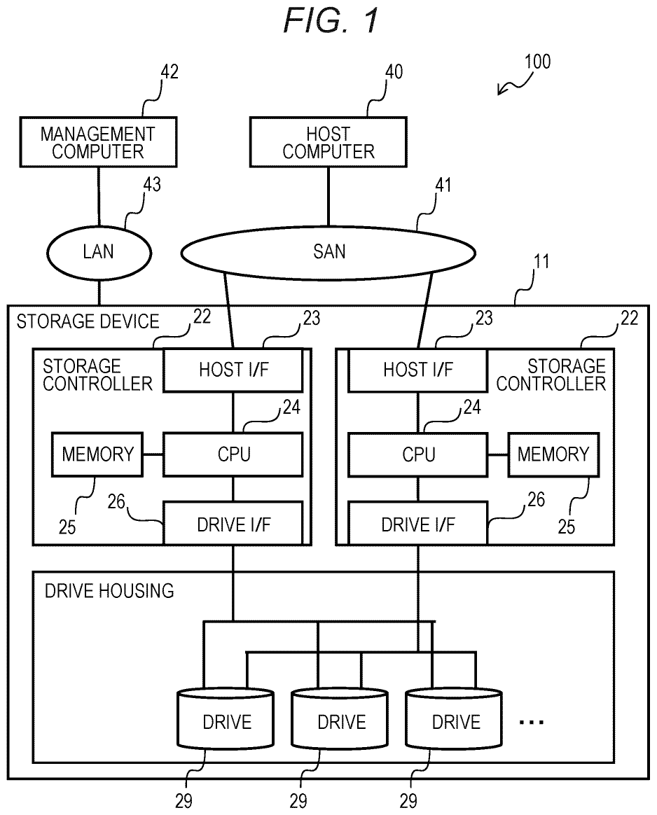

In the present embodiment, a storage device adopts a write-once data storage scheme. FIG. 1 is a diagram schematically illustrating an overview of a storage system 100 according to the present embodiment. The storage system 100 includes a storage device 11, a host computer 40 connected to the storage device 11, and a management computer 42 connected to the storage device 11.

The storage device 11 receives an I/O command from one or more host computers 40 via the first communication network 41 (for example, a storage area network (SAN)). The management computer 42 and the storage device 11 can communicate with each other via a second communication network 43 (for example, a local area network (LAN)).

The host computer 40 and the management computer 42 may be physical computers or virtual computers executed on physical computers. The storage device 11 includes one or more storage controllers 22 and a plurality of storage drives 29 (also simply referred to as drives) connected to the one or more storage controllers 22. In a configuration example of FIG. 1, the storage device 11 includes two storage controllers 22.

Each storage controller 22 includes a host interface (I/F) 23 that communicates with the host computer 40, a CPU 24 that controls the entire apparatus, a memory 25 that stores programs and information to be used by the CPU 24, and a drive I/F 26 that communicates with the physical drive 29. The number of these components is any number. In the configuration example illustrated in FIG. 1, the plurality of drives 29 are accommodated in a drive housing. The drive 29 is, for example, a device that includes a nonvolatile data storage medium, and may be a solid state drive (SSD) or a hard disk drive (HDD).

### <Overview of Asynchronous Process Control Method>

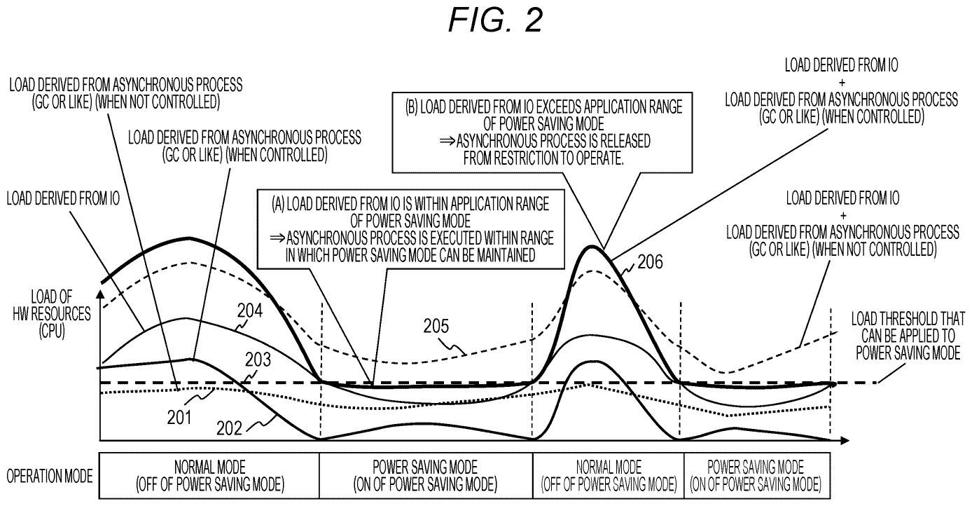

FIG. 2 is a diagram illustrating an overview of a method of controlling an asynchronous process according to an embodiment of the present specification. Here, the synchronous processing in response to an input output (IO) request from the host is a series of processes from reception of the IO request from the host to return of a response (for example, read data or a write completion response) to the host. The asynchronous process is a process other than a synchronous process.

In FIG. 2, the vertical axis represents a load of a hardware device (CPU in FIG. 2) included in the storage system, and the horizontal axis corresponds to time. The storage system operates an asynchronous process that is a process executed asynchronously with processing related to reading and writing of host data within a range of a load that can maintain the power saving mode of the hardware device. The asynchronous process includes a garbage collection process, an asynchronous compression process that is an asynchronous data amount reducing process, and an asynchronous deduplication process.

A line 201 indicates a load derived from the asynchronous process when the asynchronous process is not restricted. A line 202 indicates a load derived from the asynchronous process when the asynchronous process is restricted. A line 203 indicates a load threshold that can be applied to the power saving mode. A line 204 indicates a load derived from a host access process (derived from IO). A line 205 indicates a sum of a load derived from a host access process (derived from IO) and a load derived from an asynchronous process when control is not executed. A line 206 indicates a sum of the load derived from the host access process (derived from IO) and the load derived from the asynchronous process in the case of the restriction.

Specifically, the storage system controls the asynchronous process based on, for example, the following (A) and (B).
(A) When a load derived from the host access process (derived from IO) falls within a range to which the power saving mode of the device can be applied, the power saving mode is set to ON. The asynchronous process is executed while being restricted to a load range in which ON of the power saving mode of the hardware device can be maintained.
(B) When a load derived from the host access process (derived from IO) exceeds the range to which the power saving mode of the device can be applied, the power saving mode is set to OFF and the restriction of the asynchronous process is released to operate.

That is, the processor of the storage device selects and sets one of the normal mode and the power saving mode as an operation mode of the hardware device based on the load derived from the host access process (derived from IO). When the power saving mode is selected, an asynchronous process (the garbage collection process, the asynchronous data amount reducing process, or the like) executed separately from the host access process is controlled, and the power saving mode is maintained by maintaining the load of the hardware device including the load derived from the host access process and the load derived from the asynchronous process at a predetermined threshold or less. Accordingly, in the storage system, an execution time of the asynchronous process such as the garbage collection process necessary for continuing the operation of the storage system can be secured while securing an application period of the power saving mode of the device.

### <Logical Configuration>

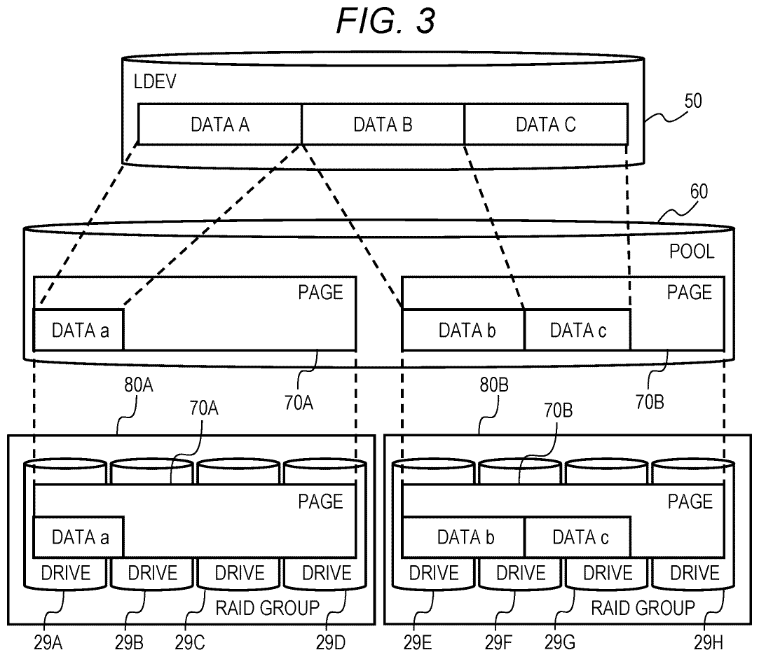

FIG. 3 is a diagram illustrating a storage logic configuration according to the present embodiment. An LDEV 50 is a logical drive recognized by the host computer 40, and the host I/O is executed for a logical address space on the LDEV 50.

A pool 60 is a logical storage area (also simply referred to as a logical area) associated with one or more LDEVs 50 and one or more RAID groups 80. In the present embodiment, user data stored in the LDEV 50 is compressed and/or de-duplicated to be stored in the pool 60. For example, each of data A, data B, and data C in the LDEV 50 is compressed to generate data a, data b, and data c. The data a, the data b, and the data c are stored in the pool 60. The data a is stored in a page 70A, and the data b and the data c are stored in a page 70B. The data amount reducing process such as a compression/deduplication process may be omitted.

The pool 60 is managed by a page 70. The page 70 is a unit area for managing the pool 60 and is associated with a logical storage area in a RAID group 80. In each page 70, the compressed data is arranged in a front-packed manner. Accordingly, data can be efficiently stored.

In both update writing and new writing by the host computer 40, the received user data is stored at the head of an available area in the page 70. When existing user data is updated by the host computer 40, the new user data is stored at the head of the available area in the page 70, and originally stored old user data becomes garbage.

The page 70 is a logical storage area for storing data. The page 70 is associated with a logical storage area in the RAID group 80 including a plurality of drives 29. In the configuration example of FIG. 3, the page 70A in the pool 60 is allocated to a RAID group 80A, and the page 70B is allocated to a RAID group 80B.

The RAID group 80 includes a plurality of drives 29. By configuring a logical storage medium by combining the plurality of drives 29, redundancy is ensured when a drive in the RAID group 80 fails. The logical storage area of the RAID group 80 is associated with the physical storage area of the drive 29.

As illustrated in FIG. 3, the storage logical configuration has a hierarchical structure, and the storage device 11 manages data in a plurality of logical hierarchies. FIG. 3 illustrates a hierarchy of the LDEV 50, a hierarchy of the RAID group 80, and a hierarchy of the pool 60 therebetween. The hierarchy of the pool 60 is a write-once hierarchy in which user data received via the host interface 23 is written in an available area. FIG. 3 illustrates one LDEV 50 and one pool 60, but a plurality of LDEVs and a plurality of pools can be defined in the storage device 11. The storage areas in the hierarchy are associated with storage areas in adjacent upper and/or lower hierarchies. Although FIG. 3 illustrates three logical hierarchies, other hierarchies may be defined.

### <Metadata Management Table>

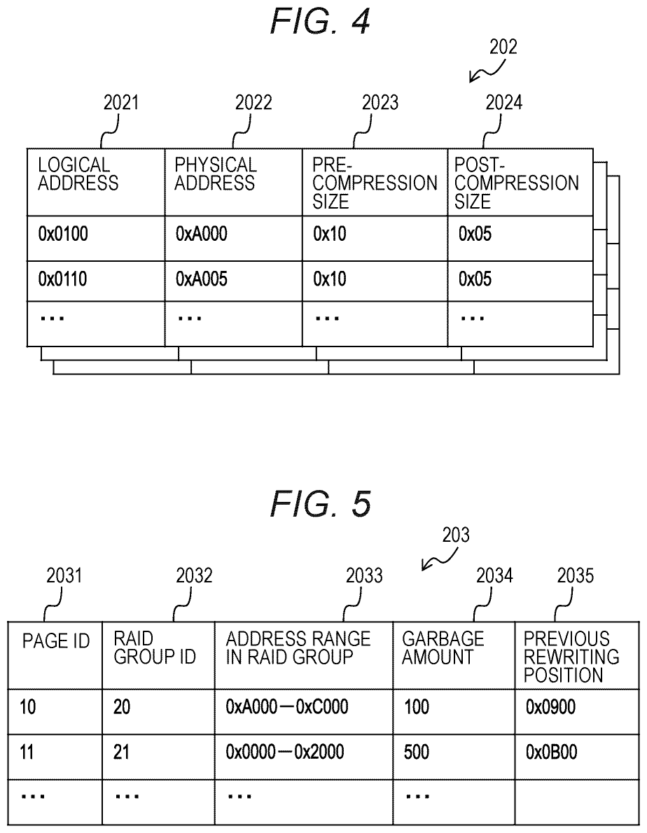

FIG. 4 is a diagram illustrating a metadata management table 202 according to the present embodiment. The CPU 24 forms the metadata management table 202. The metadata management table 202 is managed by the CPU 24, is stored in the drive 29, and is loaded to the memory 25, for example. The metadata management table 202 is managed, for example, in units of LDEVs 50. Each entry of the metadata management table 202 is a table in which a correspondence relationship between a logical address of user data included in each LDEV 50 and a physical address that is a storage destination of the data is managed. The physical address may be an address in the RAID group 80 or an address in the pool 60.

Each column of the metadata management table 202 will be described below.

At a column 2021, a start address in the address range in the corresponding LDEV 50 is recorded.

At a column 2022, the start address in the address range in the RAID group 80 is recorded as a storage destination address of the user data. To facilitate description, an address in the RAID group 80 is referred to as a physical address for convenience. As the storage destination address of the user data, an address in the pool 60 may be used instead of the address in the RAID group.

At a column 2023, a pre-compression data size of the corresponding user data is recorded.

At a column 2024, a post-compression data size of the corresponding user data is recorded.

### <Page Management Table>

FIG. 5 is a diagram illustrating a page management table 203 according to the present embodiment. The CPU 24 forms the page management table 203. The page management table 203 is managed by the CPU 24, is stored in the drive 29, and is loaded to the memory 25, for example. At each entry of the page management table 203, a correspondence relationship among a page 70 that is a logical recording area, an ID of the RAID group 80 associated with the page 70, and an address range corresponding to the page 70 in the RAID group 80 is recorded. A garbage amount included in the page 70 and a tail address (previous rewriting address) at which rewriting has been executed last in the page are recorded.

Hereinafter, each column of the page management table 203 will be described. At a column 2031, an ID indicating page 70 is recorded. At a column 2032, an ID indicating the RAID group 80 to which the page 70 is allocated is recorded. At a column 2033, an address range in the RAID group 80 corresponding to the page 70 is recorded. At a column 2034, a garbage amount included in the page 70 is recorded.

At a column 2035, a position where the data is rewritten last (end address) in the page 70 is recorded. A rewriting process is executed from a head address of the page 70 in a front-packed manner. Therefore, an area after the tail address is an area where data is not stored (that is, data can be written).

### <Raid Configuration Management Table>

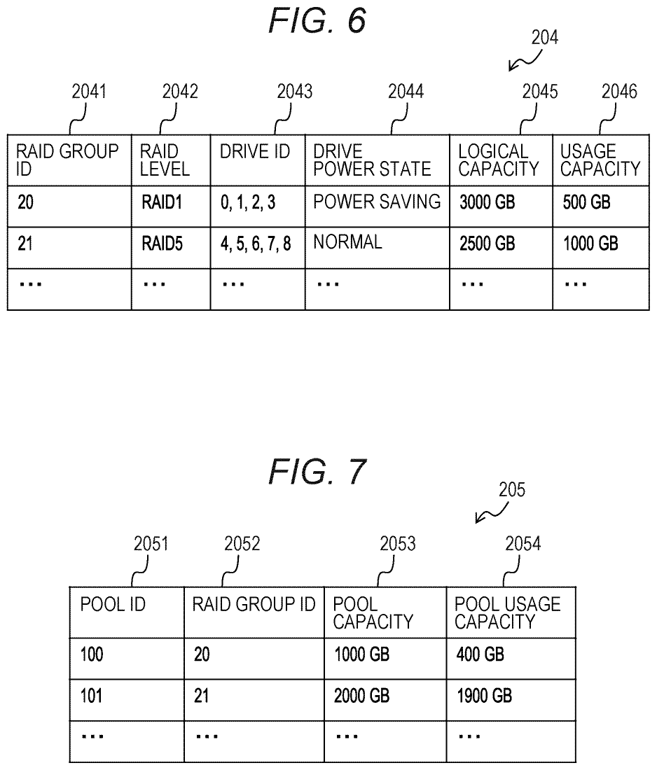

FIG. 6 is a diagram illustrating a RAID configuration management table 204 according to the present embodiment. The RAID configuration management table 204 is managed by the CPU 24, is stored in the drive 29, and is loaded to the memory 25, for example. The RAID configuration management table 204 is a data structure in which a RAID level of the RAID group 80, a list of IDs corresponding to the drives 29 belonging to the RAID group 80, types of the drives included in the RAID group 80, a logical capacity of the RAID group 80, and a usage capacity of the RAID group 80 are recorded for each RAID group 80 in the storage system.

Hereinafter, each column of the RAID configuration management table 204 will be described. At a column 2041, an ID of the RAID group 80 included in the storage system 100 is recorded. At a column 2042, a RAID level (for example, RAID1, RAID5, or the like) of the corresponding RAID group 80 is recorded. At a column 2043, a list of drive IDs belonging to the corresponding RAID group 80 is recorded.

At a column 2044, a power state (the power saving mode or the normal mode) of the drive belonging to the corresponding RAID group 80 is recorded. At a column 2045, a logical capacity of the corresponding RAID group 80 is recorded. At a column 2046, a usage capacity of the corresponding RAID group 80 is recorded. The usage capacity is a sum of sizes of areas used to store data (for example, user data or metadata) in the RAID group 80.

The CPU 24 acquires a RAID level from the user and stores the RAID level at the column 2042. The CPU 24 may acquire a drive ID from the user and store the drive ID in the CPU 24, or the CPU 24 may generate and store a drive ID. When the CPU 24 generates the drive ID, for example, the drive ID may be uniquely determined from the physical position of the drive 29. Information regarding other columns is generated and stored by the CPU 24. For example, the CPU 24 determines the power state of the drive based on load information acquired from the drive 29, and stores the power state at the column 2044.

### <Pool Management Table>

FIG. 7 is a diagram illustrating a pool management table 205 according to the present embodiment. The pool management table 205 is generated and managed by the CPU 24, is stored in the drive 29, and is loaded to the memory 25, for example. For each pool in the storage system 100, the pool management table 205 has an ID of the pool 60, a list of IDs of the RAID groups 80 corresponding to the pool 60, a logical capacity of the pool 60, and a usage capacity of the pool 60.

Each column of the pool management table 205 will be described below. At a column 2051, an ID of the pool 90 included in the storage system 100 is recorded. At a column 2052, a list of IDs of the RAID groups 80 that give a page to the corresponding pool 60 is recorded. One or more RAID groups are allocated to one pool. For example, it is assumed that drive types of the RAID groups allocated to one pool are common. At a column 2053, a logical capacity of the corresponding pool 60 is recorded.

At a column 2054, a usage capacity of the corresponding pool 60 is recorded. The usage capacity is a sum of sizes of areas used to store data (for example, user data and metadata) in the pool 60.

### <Device Management Table>

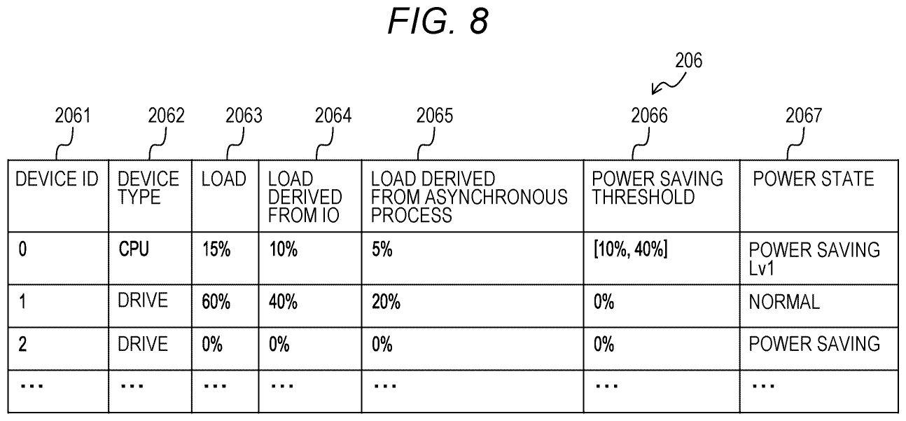

FIG. 8 is a diagram illustrating a device management table 206 according to the present embodiment. The pool management table 205 is generated and managed by the CPU 24, is stored in the drive 29, and is loaded to the memory 25, for example. The device management table 206 is a data structure in which an ID of the device, a device type indicating a type (for example, a CPU, a drive, and the like) of device, an operation rate of the device, a load of the device, a power saving threshold of the device, and a power state of the device are recorded for each device in the storage system 100.

Hereinafter, each column of the device management table 206 will be described. At a column 2061, an ID of the corresponding device is recorded.

At a column 2062, a device type indicating a type of corresponding device is recorded. Examples of the device type include a CPU and a drive. Other device types may include a compression accelerator, a memory, a front-end interface, and a back-end interface.

At a column 2063, a load of the corresponding device is recorded. The load of the device includes a load derived from a host access process (derived from IO) and a load derived from asynchronous process, and these values are managed by the column 2063. For example, the load of the CPU can be indicated at an operation rate (a ratio of an operation time of the CPU to an entire time), and the load of the drive can be indicated at a ratio of a current value to a prescribed maximum possible value of the number of accesses and an access flow rate. The load of the memory, the interface, and the accelerator may be similar to those of the drive. The device load may be managed for each process. The device load may be calculated from a value of a column 2064 (a load derived from a host access process (IO)) and a value of a column 2065 (load derived from an asynchronous process) without managing the device load.

At the column 2064, a load of a process derived from a host access (derived from IO) among loads of corresponding devices is managed. At a column 2065, a load derived from an asynchronous process among the loads of the corresponding devices is managed. The load derived from the asynchronous process may be managed for each type of asynchronous process (a garbage collection process, an asynchronous data amount reducing process, and the like).

At a column 2066, a power saving threshold of the corresponding device is recorded. The power saving threshold is one of thresholds used when a power state is determined according to the load of the device. For example, the CPU 24 periodically monitors the load derived from the host access process (derived from IO) indicated by the column 2064, and causes the power state of the device to transition to the power saving mode when the value is equal to or less than the power saving threshold. A plurality of power saving thresholds may be set according to the number of power states of the device.

At a column 2067, the power state of the corresponding device is recorded. For example, one of the power saving mode and the normal mode is set as the power state. In order to execute finer power state control, the power saving mode may be subdivided (for example, a power saving mode Lv1, a power saving mode Lv2 having a power consumption amount greater than the power saving mode Lv1, and the like).

### <Write Process>

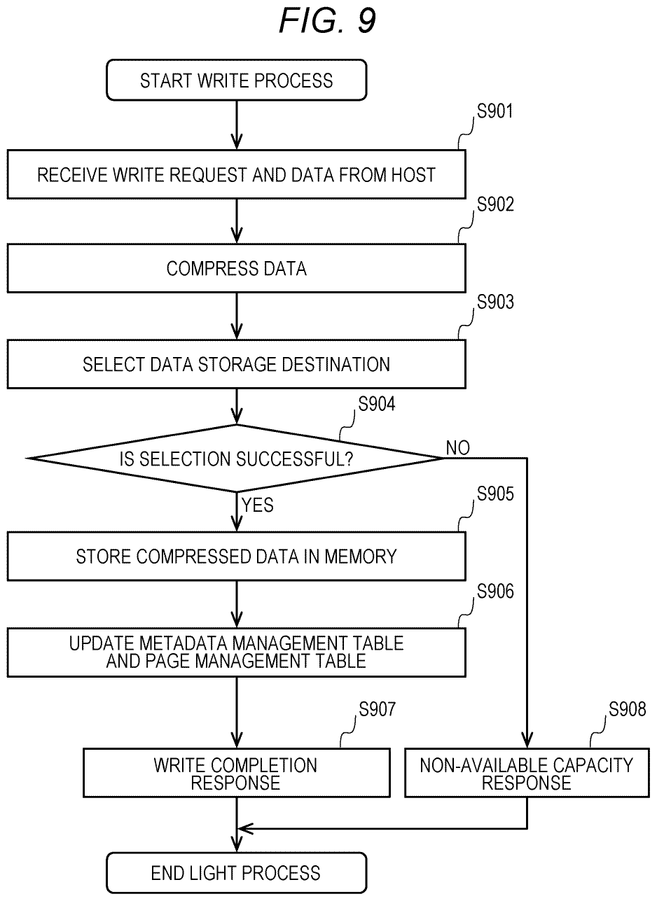

FIG. 9 is a diagram illustrating a processing flow of the write process in the present embodiment. The write process is a process of receiving a write request from the host computer 40 and recording data in the storage device 11. In the write request, for example, an LDEV ID and a logical address of a write destination are designated by the host computer 40.

Hereinafter, a processing flow of the write process according to the present embodiment will be described with reference to FIG. 9.

S901: The CPU 24 receives a data write request and data from the host computer 40.

S902: The CPU 24 applies a compression process to the data received from the host computer 40 to obtain compressed data. The compression process may be executed by the CPU 24 itself, or when hardware capable of executing the compression process is included in the storage device 11, the hardware may be caused to execute the compression process.

S903: The CPU 24 selects a destination page 70 to store the compressed data. The CPU 24 refers to the page management table 203, the RAID configuration management table 204, and the pool management table 205. A size from a final rewriting position to a page end of the page is set as an in-page available area, and the page 70 in which the in-page available area is greater than the size of the compressed data is selected as a data storage destination page.

S904: When a page satisfying a condition can be selected as the storage destination page in step S903, the CPU 24 proceeds to step S905. When there is no page satisfying the condition, the process proceeds to step S908. S905: The CPU 24 stores the compressed data in the memory 25.

S906: The CPU 24 updates values of the physical address 2022, the pre-compression size information 2023, and the post-compression size information 2024 corresponding to the page ID 2021 and the logical address 2021 in the page in the metadata management table 202. In the case of the update writing, a value of the garbage amount 2034 corresponding to the page 70 storing pre-update data in the page management table 203 is increased by a size of the pre-update data. Accordingly, the garbage amount data is managed. A value of the previous rewriting position 2035 is updated with the value of the rewriting position in which the compressed data is stored this time.

S907: The CPU 24 returns a response of write process completion to the host computer 40, and ends the process. S908: The CPU 24 returns a response indicating that the write process has failed due to insufficient available capacity to the host computer 40, and ends the process.

In description of FIG. 9, the compression process is executed before the write completion response to the host computer 40, but this compression process may be executed asynchronously with the write process. For example, after the data received from the host computer 40 is stored in the memory 25, a write completion response to the host computer 40 is made, and then the compression process may be executed asynchronously for the data on the memory 25.

### <Garbage Collection Process>

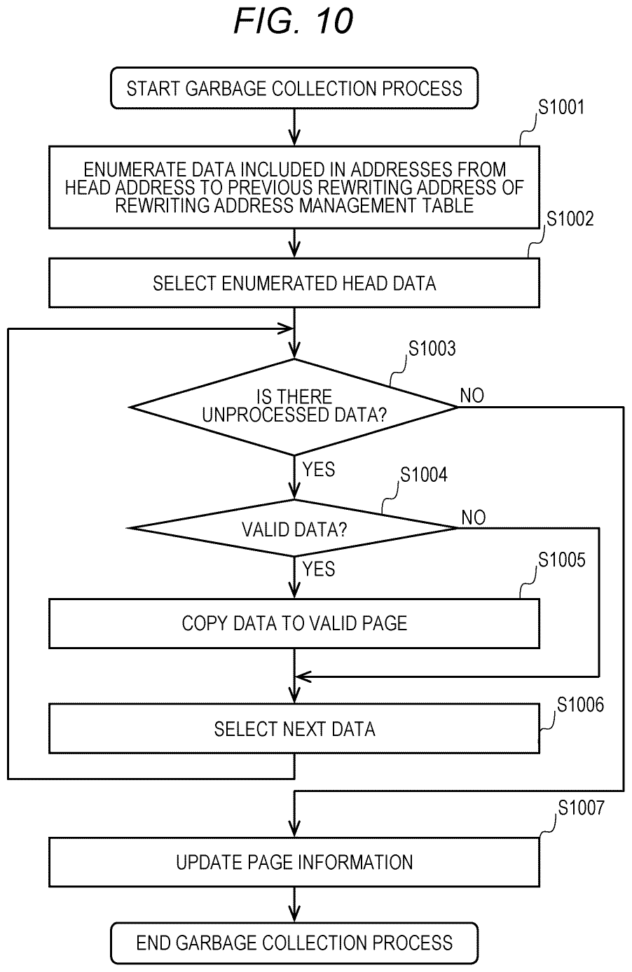

FIG. 10 is a diagram illustrating a processing flow of the garbage collection process according to the present embodiment. The garbage collection process is a process of releasing a storage area occupied by the garbage so that the storage area can be reused by transferring only valid data among valid data and garbage included in the target page 70 to another page and then discarding the target page 70.

The CPU 24 executes the garbage collection process on the storage area (for example, the page 70) determined to be a garbage collection execution target in the asynchronous process execution determining process to be described below.

The CPU 24 may periodically execute the garbage collection process on the page 70 determined to be the garbage collection execution target, or may execute the garbage collection process executed synchronously or asynchronously with the write process when the garbage amount included in the pool 60 or the page 70 is increased through the write process.

The garbage collection process may be executed when the logical configuration in the storage system 100 is changed. For example, it may be executed when the size of the LDEV 50, the pool 60, or the RAID group 80 is changed.

Alternatively, the change in the physical configuration in the storage system 100 may be used as a trigger for the execution. For example, addition or removal of the drive 29 may be used as a trigger.

Hereinafter, a processing flow of the garbage collection process according to the present embodiment will be described with reference to FIG. 10.

S1001: The CPU 24 enumerates the data included in the address range from the head address of the target page to the previous rewriting position with reference to the page management table 203.

S1002: The CPU 24 selects head data among the data enumerated in step S1001 as a processing target.

S1003: The CPU 24 determines whether there is unprocessed data among the data enumerated in step S1001. When there is the unprocessed data (S1003: YES), the process proceeds to step S1004. When there is no unprocessed data (S1003: NO), all the valid data included in the page 70 has been transferred to another page 70, and thus the garbage collection process ends.

S1004: The CPU 24 determines whether the target data is valid data with reference to the physical address information 2022 and logical address information in the metadata management table 202. When there is a corresponding logical address for the physical address at which the target data is located, it is determined that the target data is valid data. Otherwise, it is determined that the target data is not valid data. When the data is the valid data (S1004: YES), the process proceeds to step S1005. When the data is not the valid data (S1004: NO), the process proceeds to step S1006.

S1005: The CPU 24 copies the target data to another page 70 in the pool 60.

S1006: The CPU 24 selects next data from the data enumerated in step S1001, and proceeds to step S1203.

S1007: The CPU 24 rewrites the value of the garbage amount 2034 and the value of the previous rewriting position 2035 to initial values among the entries corresponding to the target page 70 with reference to the page management table 203.

### <Asynchronous Process Execution Determining Process>

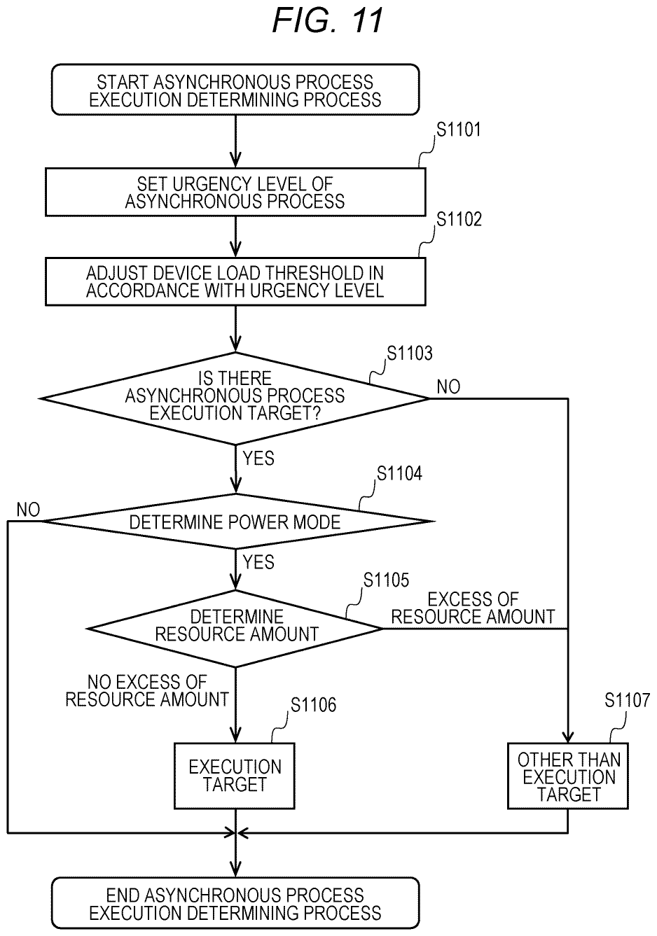

FIG. 11 is a diagram illustrating a processing flow of the asynchronous process execution determining process according to the present embodiment. The asynchronous process execution determining process is a process of determining whether to execute the garbage collection process or the asynchronous data amount reducing process for each pool 60 in the storage system 100.

The asynchronous process execution determining process may be periodically executed by the CPU 24 or may be executed at a start trigger set for each asynchronous process. For example, the garbage collection process may be executed synchronously or asynchronously with the write process when the garbage amount included in the pool 60 or the page 70 is increased by a certain amount through the write process.

The asynchronous process execution determining process may be executed when the logical configuration in the storage system 100 is changed. For example, it may be executed when the size of the LDEV 50, the pool 60, or the RAID group 80 is changed. Alternatively, the change in the physical configuration in the storage system 100 may be used as a trigger for the execution. For example, addition or removal of the drive 29 may be used as a trigger.

Hereinafter, a processing flow of the asynchronous process execution determining process according to the present embodiment will be described with reference to FIG. 11. The following description will be made using a garbage collection process as an example of the asynchronous process.

S1101: The CPU 24 determines an urgency level for executing the asynchronous process. In the determination of the urgency level of the garbage collection process, for example, a pool capacity and a pool usage capacity of the target pool 60 are acquired with reference to the pool management table 205, and a pool available capacity is calculated from a difference between the pool capacity and the pool usage capacity.

Subsequently, the CPU 24 determines an urgency level (hereinafter referred to as a GC urgency level) of the garbage collection process in accordance with the calculated available capacity (for example, “urgency level: medium, non-urgent”, or the like). When the available capacity is small and the possibility of depletion (for example, the available capacity less than the predetermined threshold) is high, the GC urgency level is set to be high to operate the garbage collection process and execute control to recover the available capacity. Conversely, when there is a margin in the available capacity, the GC urgency level is set to be low and the garbage collection process is operated with a load within a range in which the power saving mode can be maintained, and thus control for focusing on power saving is adopted.

The urgency level may be determined using one or a plurality of fixed thresholds for the available capacity of the pool 60 or may be determined by a dynamic threshold in accordance with a usage status of the storage system. For example, the threshold may be changed based on a garbage collection process speed (an available capacity of a pool that can be generated per unit time through the garbage collection process) and a speed of an increase in a pool usage by the host write.

These values are monitored and managed by the CPU 24. For example, an average value for each predetermined period or a moving average over time may be calculated. For example, a function or a conversion table may be defined in which the higher the garbage collection process speed is, the smaller the threshold is, and the higher the speed of increase in the pool usage is, the larger the threshold is.

As the urgency level is higher, the garbage collection process is actively executed. Therefore, the pool available capacity increases and the pool is less likely to be depleted. Conversely, since a usage rate of the device increases by positively executing the garbage collection process, it is difficult to transition to the normal mode. Even when the urgency level is not the available capacity of the pool, the urgency level may also be determined based on the available capacity of the data storage area, such as an available capacity of one or more LDEVs or pages different from the pool and the available capacity of a physical drive, which are targets of the garbage collection process.

S1102: The CPU 24 adjusts the load threshold of each device in accordance with the GC urgency level determined in S1101. For example, when the GC urgency level is “non-urgent”, it can be determined that an execution priority of the garbage collection is low. At this time, the power saving threshold set in the device management table 206 is used as a device load threshold.

Conversely, when the GC urgency level is “medium”, it is determined that it is necessary to preferentially execute the garbage collection, and a value higher than the power saving threshold of the device management table 206 is set as the device load threshold. Similarly, when the GC urgency level is “high”, the device load threshold is set higher. Accordingly, the garbage collection can be actively operated. A relationship between the GC urgency level and the device load threshold may be set in advance, and only the device load thresholds of some predetermined devices may be changed. The GC urgency level may not be used. In this case, the device load threshold may be fixed.

S1103: The CPU 24 executes following determination (X1) for all the pages 70 corresponding to the target pool 60 with reference to the page management table 203.

(X1) The garbage amount included in the target page 70 is equal to or more than a page unit garbage amount threshold.

When there are one or more pages 70 for which a result of the determination (X1) is positive among the target pages 70, the CPU 24 proceeds to S1104. Otherwise, the process proceeds to S1107.

S1104: The CPU 24 determines a power mode of the device. When the load derived from the host access process (derived from IO) does not reach the device load threshold determined in S1102, the CPU 24 determines that the power saving mode is applicable and the process proceeds to S1105.

Conversely, when the load derived from the host access process (derived from IO) reaches the device load threshold determined in S1102, it is determined that the power saving mode cannot be applied (normal mode). In this case, the subsequent steps (S1105 to S1107) are skipped, and a calculation resource amount determined in accordance with any standard within allowable maximum performance of the device is allocated to the asynchronous process.

S1105: The CPU 24 determines a calculation resource amount of each device (for example, the CPU 24 or the drive 29) to be allocated to the asynchronous process. When the value (total device load) obtained by adding the calculation resource amount of the device already allocated to the asynchronous process and the calculation resource amount caused by the host access process does not reach the device load threshold determined in S1102, the CPU 24 proceeds to S1106. Otherwise, the process proceeds to S1107. The entire load of the device is managed at the column 2063 of the device management table 206.

The “calculation resource amount” is represented by, for example, an operation rate (a ratio of an operation time of the CPU 24 to an entire time) in the case of the CPU 24. In the case of the drive 29, a ratio of a currently generated access load to a maximum access load (for example, the number of accesses or an access flow rate) that can be accepted by the drive is expressed.

When the device is in the power saving mode, the CPU 24 controls the load of the garbage collection process so that the power saving mode is maintained. That is, an upper limit of the calculation resource amount allocated to the garbage collection process is determined so that the entire load of the device becomes the device load threshold determined in S1102. For example, when the calculation resource amount of the CPU 24 already allocated to the asynchronous process is 5%, the calculation resource amount caused in the host access process is 30%, and the device load threshold determined in S1102 is 40%, the process proceeds to S1106. Then, “10%” is determined as the upper limit of the calculation resource amount allocated to the garbage collection process such that the entire device load becomes 40% which is the device load threshold determined in S1102.

For example, when the calculation resource amount of the CPU 24 already allocated to the asynchronous process is 20%, the calculation resource amount caused by the host access process is 30%, and the device load threshold determined in S1102 is 40%, the process proceeds to S1107. Then, “10%” is determined as the upper limit of the calculation resource amount allocated to the garbage collection process such that the entire device load becomes 40% which is the device load threshold determined in S1102.

In the case of the garbage collection process, the calculation resource amount allocated to the garbage collection process may be set to a value (for example, in the above example, a value such as 7% less than 10% which is an upper limit) less than the upper limit as a target value of the calculation resource amount allocated to the process. The target value of the calculation resource amount may be changed in accordance with the pool available capacity.

On the other hand, in the drive 29, when an access occurs (there is an incomplete command to the drive), the power saving mode may not be maintained. In the drive 29 that has such characteristics, for example, the garbage collection process may be executed only when a drive access (for example, drive access in a host access synchronization process) caused in the host access process occurs on the drive 29.

Accordingly, an application period of the power saving mode of the drive is secured while there is no host access, and the garbage collection process operates when the host access occurs (at this time, new garbage increases due to host writing). Accordingly, by collecting the available capacities, it is possible to achieve both power saving and maintenance of the available capacities.

The calculation resource amount allocated to the garbage collection process may be controlled through, for example, the degree of parallelism (parallel execution number) of the garbage collection process. In this case, the calculation resource amount increases in proportion to the degree of parallelism. For example, a relationship between the calculation resource amount and the degree of parallelism may be set in advance, and the degree of parallelism may be determined such that the device load is within a threshold. Alternatively, the CPU 24 may monitor the device load and change the degree of parallelism at any time.

S1106: The CPU 24 determines that the target pool 60 is a garbage collection execution target and ends the process. That is, in order to increase the calculation resource amount of the device already allocated to the asynchronous process to the calculation resource amount allocated to the garbage collection process determined in S1105, it is determined to newly execute the garbage collection process, and the process ends.

S1107: The CPU 24 determines that the target pool 60 is not subjected to the garbage collection, and ends the process. That is, the calculation resource amount of the device already allocated to the asynchronous process is decreased to the calculation resource amount allocated to the garbage collection process determined in S1105, it is determined that the garbage collection process is not newly executed, and the process ends.

Through the above-described asynchronous process execution determining process described using the garbage collection process as an example, in order to prevent depletion of the pool capacity, the calculation resource amount is allocated such that the smaller the available capacity is (for example, the higher the urgency level is), the higher the garbage collection process speed is (for example, the degree of processing parallelism).

The asynchronous process execution determining process described above using the garbage collection process as an example can be applied to the data amount reducing process and other asynchronous processes. For example, in an execution determining process for the asynchronous data amount reducing process, the urgency level and the device load threshold may be determined similarly to the garbage collection process. A target page of the data amount reducing process may be selected using a reduction target data amount as a standard. For example, in S1103, instead of determining the processing target based on the garbage amount in the page, a page in which the data amount of the reduction target is a predetermined threshold or more is selected. Accordingly, the reduction target can be appropriately selected.

### <Asynchronous Data Amount Reducing Process>

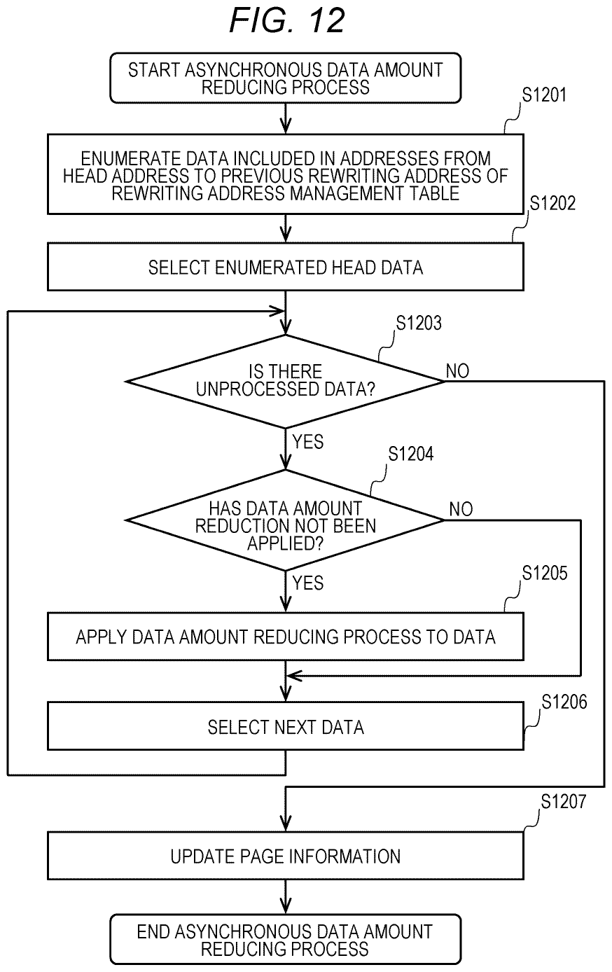

FIG. 12 is a diagram illustrating a processing flow of an asynchronous data amount reducing process according to the present embodiment. The asynchronous data amount reducing process is a process of applying the data amount reducing process to data to which data reduction is not applied among the data included in the target page 70.

In the asynchronous process execution determining process, the CPU 24 executes the asynchronous data amount reducing process on a storage area (for example, the page 70) determined to be an asynchronous data reduction execution target.

The CPU 24 may periodically execute the asynchronous process execution determining process on the page 70 determined to be the execution target of the asynchronous data amount reducing process, or may execute the asynchronous process execution determining process in response to an increase in the data amount to which the data amount reducing process is not applied and which is included in the pool 60 or the page 70 in the write process.

The asynchronous data amount reducing process may be executed in response to a change in the logical configuration in the storage system 100. For example, it may be executed when the size of the LDEV 50, the pool 60, or the RAID group 80 is changed.

Alternatively, the change in the physical configuration in the storage system 100 may be used as a trigger for the execution. For example, addition or removal of the drive 29 may be used as a trigger.

Hereinafter, a processing flow of the asynchronous data amount reducing process according to the present embodiment will be described with reference to FIG. 12.

S1201: The CPU 24 enumerates the data included in an address range from the head address of the target page to the previous rewriting position with reference to the page management table 203.

S1202: The CPU 24 selects the head data among the data enumerated in step S1201 as a processing target.

S1203: The CPU 24 determines whether there is unprocessed data among the data enumerated in step S1201. When there is the unprocessed data (S1203: YES), the process proceeds to step S1204. When there is no unprocessed data (S1203: NO), reduction in the data amount has been applied to all the data included in the page 70. Therefore, the asynchronous data amount reducing process is completed.

S1204: The CPU 24 determines whether the data amount reducing process has not been applied to the target data with reference to physical address information 2022 and logical address information in the metadata management table 202. When the data amount reducing process has not been applied (S1204: YES), the process proceeds to step S1205. When the data amount reducing process has already been applied (S1204: NO), the process proceeds to step S1206.

S1205: The CPU 24 applies the data amount reducing process (a compression process or a deduplication process) to the target data. The target data is valid data, and the garbage is excluded from the target data. In addition, the compressed data is additionally written (written) to an available area of the current page or a new page.

S1206: The CPU 24 selects next data from the data enumerated in step S1201, and proceeds to step S1203.

S1207: The CPU 24 executes necessary update of the value of the garbage amount 2034 and the value of the previous rewriting position 2035 in an entry corresponding to the target page 70 with reference to the page management table 203. Specifically, the garbage amount is increased by an old data amount through the data amount reducing process. When the compressed data is written in a current page, the previous write-once position is updated to the end of the current write-once.

As described above, according to the embodiment of the present invention, it is possible to apply the asynchronous process such as the garbage collection process and the asynchronous data amount reducing process while securing an application period of the power saving mode of the hardware device included in the storage system.

In the embodiment of the present invention, the storage device manages data in a plurality of logical hierarchies, but the logical hierarchies may not be used as long as the data can be stored and managed in the storage area. In the embodiment of the present invention, the storage system adopts the write-once data storage scheme, but an asynchronous process such as an asynchronous data amount reducing process for data stored in the storage system may be executed without using the write-once data storage scheme.

In the embodiment of the present invention, a power state is managed for each device, an operation mode (power state) is selected, and an asynchronous process such as a garbage collection process and an asynchronous data amount reducing process is executed within a range in which the power saving mode is maintained. Accordingly, it is possible to execute more appropriate control for each device. In another example, the power state may be managed in the entire storage device, an operation mode may be selected, and an asynchronous process such as a garbage collection process or an asynchronous data amount reducing process may be executed. For example, the CPU 24 may compare a load of IOs from all the hosts with a predetermined threshold and set all the target devices of the host to the common operation mode. The resource allocation to the asynchronous process may be controlled so that the load does not exceed the load threshold for each device as in the above example.

In the embodiment of the present invention, the asynchronous process includes the garbage collection process, and the asynchronous compression process and the asynchronous deduplication process which are the asynchronous data amount reducing process. However, the process executed asynchronously with the process related to data reading and writing includes a process different from the garbage collection process and the asynchronous data amount reducing process. For example, the asynchronous process may include a process of asynchronously executing staging from a drive to a cache, an asynchronous destaging process associated with a writeback process, and a process of asynchronously executing compression mode conversion for changing application of a plurality of compression algorithms.

When a load of a specific RAID group in the storage system is not generated, writing is not executed in the RAID group, and thus, an available capacity of the RAID group is not depleted. Therefore, it may be determined that priority of the garbage collection process on the RAID group is low, and the group may be excluded from an execution target of the garbage collection. Accordingly, an application period of the power saving mode can be secured for each drive associated with the RAID group.

The execution of the asynchronous process for a period in which the power saving mode is not applied may be accelerated according to a length of a period in which the power saving mode is applied and the magnitude of a load (for example, a restricted amount of an operation rate) derived from the asynchronous process restricted by the power saving mode. For example, when the load caused due to the restriction of the garbage collection process is equal to or greater than a predetermined threshold and the operation mode is the normal mode, the CPU 24 increases the degree of parallelism (parallel execution number) of the garbage collection process so that the degree of parallelism is greater than the predetermined degree of parallelism in order to accelerate and execute the garbage collection process.

In the garbage collection process, as the period in which the load is restricted is longer (as an absolute value of the load derived from the restricted garbage collection is greater), an uncollected garbage amount increases. In this case, it is possible to efficiently collect the increased garbage by accelerating the garbage collection process for the period in which the power saving mode is not applied.

The present invention is not limited to the above-described embodiments and includes various modifications. For example, the above-described embodiments have been described in detail to facilitate understanding of the present invention, and are not necessarily limited to those having all the described configurations. Some of the configurations of a certain embodiment can be replaced with the configurations of another embodiment, and the configurations of another embodiment can be added to the configurations of the certain embodiment. It is possible to add, delete, and replace other configurations to, from, and with the configurations of each embodiment.

Some or all of the above-described configurations, functions, processing units, and the like may be implemented with hardware, for example, by designing the configurations, functions, processing units, and the like with integrated circuits. Each of the above-described configurations, functions, and the like may be implemented with software by a processor interpreting and executing a program for implementing each function. Information such as a program, a table, and a file for implementing each function can be stored in a recording device such as a memory, a hard disk, and an SSD, or a recording medium such as an IC card and an SD card.

Control lines and information lines indicate what is considered to be necessary for the description, and do not necessarily indicate all the control lines and the information lines on a product. In practice, it may be considered that almost all the configurations are connected to each other.

What is claimed is:

1. A storage device comprising:
a host interface configured to communicate with a host; and
a processor,
wherein the processor
executes an asynchronous process that is a process executed asynchronously with an access process that is a process related to reading and writing of data via the host interface and is a process on data derived from data received via the host interface,
selects an operation mode of one or more hardware devices of the storage device from modes including a normal mode and a power saving mode in which a power consumption amount is less than a power consumption amount of the normal mode, and
restricts the asynchronous process and maintains the power saving mode when the operation mode is the power saving mode.

2. The storage device according to claim 1, wherein
the processor
sets the power saving mode as the operation mode when an access-derived load that is a load applied to the access process is equal to or less than a predetermined device load threshold, and
controls the asynchronous process so that, in the restriction of the asynchronous process, a device load including the access-derived load and an asynchronous process-derived load that is a load applied to the asynchronous process is equal to or less than the predetermined device load threshold.

3. The storage device according to claim 2, wherein
the processor manages the access-derived load and the asynchronous process-derived load for each of the one or more hardware devices,
the one or more hardware devices include the processor and a physical drive,
the processor selects the operation mode for each of the one or more hardware devices, and
the asynchronous process is restricted for each of the one or more hardware devices when the operation mode is the power saving mode.

4. The storage device according to claim 1, wherein
the processor
stops the asynchronous process on a physical drive to which a load derived from the access process is not applied and
maintains the power saving mode of the physical drive.

5. The storage device according to claim 1, wherein the asynchronous process includes a garbage collection process and an asynchronous data amount reducing process.

6. The storage device according to claim 2, wherein
the device load threshold includes a first device load threshold and a second device load threshold greater than the first device load threshold, and
the processor
selects the first device load threshold as the device load threshold when an available capacity of a data storage area that is a target of the asynchronous process is greater than a predetermined threshold, and
selects the second device load threshold as the device load threshold when the available capacity of the data storage area is equal to or less than the predetermined threshold.

7. The storage device according to claim 5, wherein the processor executes the asynchronous data amount reducing process in a storage area where an amount of target data of the asynchronous data amount reducing process is equal to or greater than a predetermined threshold.

8. The storage device according to claim 1, wherein the area where the asynchronous process is executed is a storage area of a physical drive that has a load equal to or greater than a predetermined threshold.

9. The storage device according to claim 5, wherein the processor accelerates the garbage collection process when a load caused by the restriction of the garbage collection process is equal to or more than a predetermined threshold and the operation mode is the normal mode.

10. The storage device according to claim 1, wherein
data stored in a storage drive is managed in a plurality of logical hierarchies,
the plurality of logical hierarchies include a rewriting hierarchy, and
the processor writes data derived from data received via the host interface in a writable available area in the write-once hierarchy.

11. A control method for a storage device, the method comprising:
executing an asynchronous process that is a process executed asynchronously with an access process that is a process related to reading and writing of data via the host interface and is a process on data derived from data received via the host interface;
selecting an operation mode of one or more hardware devices of the storage device from modes including a normal mode and a power saving mode in which a power consumption amount is less than a power consumption amount of the normal mode; and
restricting the asynchronous process and maintaining the power saving mode when the operation mode is the power saving mode.
